(19) United States
(12) Patent Application Publication
(10) Pub. No.: US 2011/0146027 A1
(43) Pub. Date: Jun. 23, 2011

(54) Castor Assembly Having Adjustable Height

(76) Inventor: Po-Chuan Tsai, Rende Hsiang (TW)

(21) Appl. No.: 12/644,502

(22) Filed: Dec. 22, 2009

(51) Int. Cl. B60B 33/00

(52) U.S. Cl. 16/18 CG

(57) ABSTRACT

A castor assembly includes a castor body, a threaded rod rotatably mounted on the castor body, a lower adjusting cover surrounding the threaded rod to cover the threaded rod and secured on the threaded rod to rotate the threaded rod relative to the castor body, an upper adjusting cover surrounding the threaded rod to cover the threaded rod and retractably mounted on the lower adjusting cover, and an elastic member mounted on the threaded rod and biased between the threaded rod and the upper adjusting cover to push the upper adjusting cover outwardly relative to the lower adjusting cover. Thus, the threaded rod is covered by the lower adjusting cover and the upper adjusting cover to enhance the aesthetic quality of the castor assembly.

### BACKGROUND OF THE INVENTION

1. Field of the Invention

The present invention relates to a castor and, more particularly, to a castor assembly for a chair, a case and the like.

2. Description of the Related Art

A conventional castor assembly comprises a castor body and a threaded rod mounted on a top of the castor body. In assembly, when the castor assembly is mounted on an object, such as a chair, a case or the like, the threaded rod is screwed into the bottom of the object to attach the castor body to the object. In adjustment, when a user wishes to adjust the distance between the castor assembly and the object, the threaded rod is rotated and further screwed into the bottom of the object so as to adjust the height of the castor body. However, the threaded rod is exposed from the object after adjustment of the height of the castor body, thereby greatly decreasing the aesthetic quality of the castor assembly.

### BRIEF SUMMARY OF THE INVENTION

In accordance with the present invention, there is provided a castor assembly, comprising a castor body, a threaded rod rotatably mounted on the castor body, a lower adjusting cover surrounding the threaded rod to cover the threaded rod and secured on the threaded rod to rotate the threaded rod relative to the castor body, an upper adjusting cover surrounding the threaded rod to cover the threaded rod and retractably mounted on the lower adjusting cover, and an elastic member mounted on the threaded rod and biased between the threaded rod and the upper adjusting cover to push the upper adjusting cover outwardly relative to the lower adjusting cover.

The threaded rod has an upper end provided with a threaded portion, a lower end provided with a plug, and a mediate portion provided with a driven portion located between the plug and the threaded portion. The lower adjusting cover has an inner portion provided with a receiving chamber to receive the threaded rod and the elastic member. The inner portion of the lower adjusting cover has a lower end provided with a drive hole secured on the driven portion of the threaded rod to drive and rotate the driven portion of the threaded rod relative to the castor body. The inner portion of the lower adjusting cover has an upper end provided with a plurality of stop portions, and the upper adjusting cover has a lower end provided with a stop flange movably mounted in the receiving chamber of the lower adjusting cover and movable to abut the stop portions of the lower adjusting cover.

The primary objective of the present invention is to provide a castor assembly having an adjustable height.

According to the primary objective of the present invention, the drive hole of the lower adjusting cover is secured on the driven portion of the threaded rod so that the threaded rod is rotated by the lower adjusting cover and is screwed into and moved in the bottom of the object so as to adjust the height of the castor body.

According to another objective of the present invention, the threaded rod is disposed between the bottom of the object and the castor body and is fully covered by the lower adjusting cover and the upper adjusting cover to enhance the aesthetic quality of the castor assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a castor assembly in accordance with the preferred embodiment of the present invention.

FIG. 2 is an exploded perspective view of the castor assembly as shown in FIG. 1.

FIG. 3 is a cross-sectional view of the castor assembly taken along line 3-3 as shown in FIG. 1.

FIG. 4 is a cross-sectional view of the castor assembly taken along line 4-4 as shown in FIG. 1.

FIG. 5 is a schematic operational view of the castor assembly as shown in FIG. 4 in adjustment.

FIG. 6 is a perspective view showing the castor assembly being mounted on an object.

FIG. 7 is a schematic operational view of the castor assembly as shown in FIG. 6.

### DETAILED DESCRIPTION OF THE INVENTION

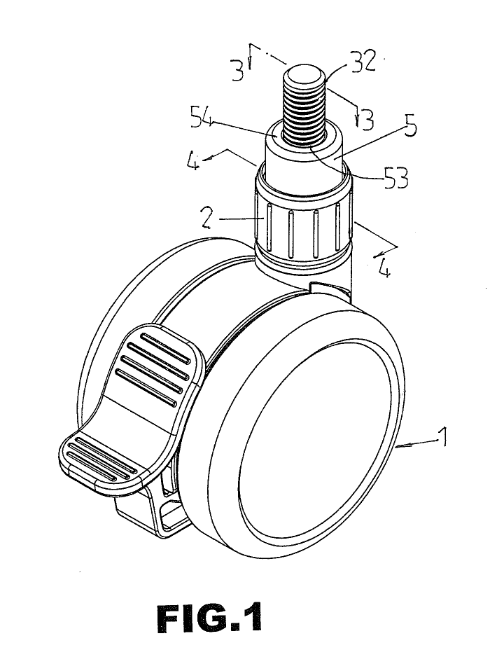

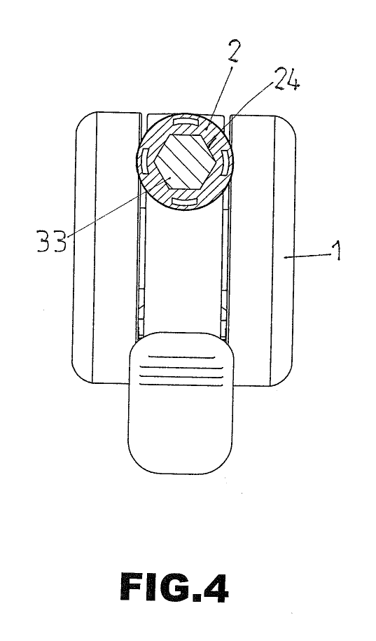

Referring to the drawings and initially to FIGS. 1-4, a castor assembly in accordance with the preferred embodiment of the present invention comprises a castor body 1, a threaded rod 3 rotatably mounted on the castor body 1, a lower adjusting cover 2 surrounding the threaded rod 3 to cover the threaded rod 3 and secured on the threaded rod 3 to rotate the threaded rod 3 relative to the castor body 1, an upper adjusting cover 5 surrounding the threaded rod 3 to cover the threaded rod 3 and retractably mounted on the lower adjusting cover 2, and an elastic member 4 mounted on the threaded rod 3 and biased between the threaded rod 3 and the upper adjusting cover 5 to push the upper adjusting cover 5 outwardly relative to the lower adjusting cover 2.

The threaded rod 3 is rotatable relative to the upper adjusting cover 5 and is movable axially relative to the upper adjusting cover 5. The threaded rod 3 is fully covered by the lower adjusting cover 2 and the upper adjusting cover 5 and has an upper end provided with a threaded portion 32, a lower end provided with a plug 31, and a mediate portion provided with a driven portion 33 located between the plug 31 and the threaded portion 32. The driven portion 33 of the threaded rod 3 has a substantially hexagonal profile and has a size greater than that of the plug 31 and greater than that of the threaded portion 32.

The castor body 1 is provided with a mounting recess 10 rotatably mounted on the plug 31 of the threaded rod 3. The mounting recess 10 of the castor body 1 has a size smaller than that of the driven portion 33 of the threaded rod 3.

The lower adjusting cover 2 is rotatable relative to the upper adjusting cover 5 and is movable axially relative to the upper adjusting cover 5. The lower adjusting cover 2 is disposed between the castor body 1 and the upper adjusting cover 5 and has an inner portion provided with a receiving chamber 21 to receive the threaded rod 3 and the elastic member 4. The inner portion of the lower adjusting cover 2 has an upper end provided with a plurality of stop portions 23 and a lower end provided with a drive hole 24 secured on the driven portion 33 of the threaded rod 3 to drive and rotate the driven portion 33 of the threaded rod 3 relative to the castor body 1. The drive hole 24 of the lower adjusting cover 2 has a substantially hexagonal profile and is connected between the mounting recess 10 of the castor body 1 and the receiving chamber 21 of the lower adjusting cover 2. The drive hole 24 of the lower adjusting cover 2 extends radially and inwardly from the lower adjusting cover 2 and has a size smaller than that of the receiving chamber 21 of the lower adjusting cover 2. The inner portion of the lower adjusting cover 2 has a periphery provided with a plurality of elongate and arcuate guide grooves 22 connected to the receiving chamber 21 and aligning with the stop portions 23 respectively. In assembly, the plug 31 of the threaded rod 3 is inserted through the receiving chamber 21 and the drive hole 24 of the lower adjusting cover 2 into the mounting recess 10 of the castor body 1.

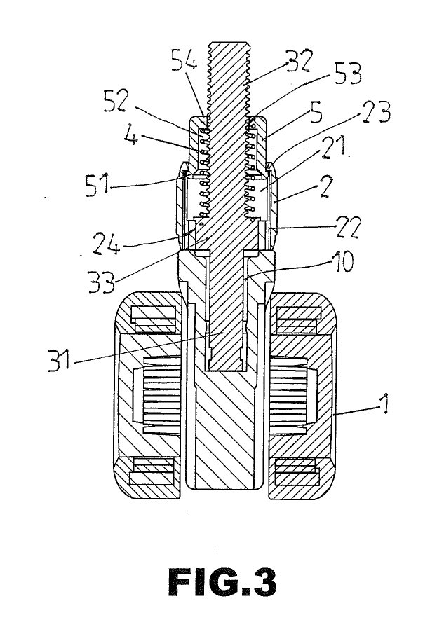

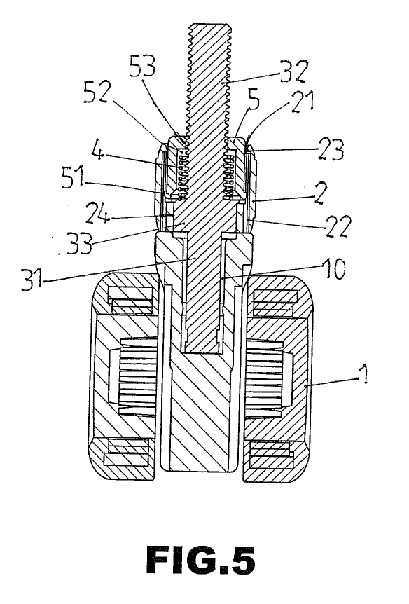

The upper adjusting cover 5 protrudes outwardly from the lower adjusting cover 2 at a normal state as shown in FIG. 3 and is retractable into the receiving chamber 21 of the lower adjusting cover 2 as shown in FIG. 5. The upper adjusting cover 5 has an inner portion provided with a receiving space 52 connected to the receiving chamber 21 of the lower adjusting cover 2 to receive the threaded rod 3 and the elastic member 4. The upper adjusting cover 5 has an upper end provided with a limit shoulder 54 to limit the elastic member 4 and a lower end provided with a stop flange 51 movably mounted in the receiving chamber 21 of the lower adjusting cover 2 and movable to abut the stop portions 23 of the lower adjusting cover 2. The limit shoulder 54 of the upper adjusting cover 5 extends radially and inwardly from the upper adjusting cover 5 and has an inner portion provided with a through hole 53 to allow passage of the threaded rod 3. The through hole 53 of the upper adjusting cover 5 is connected to the receiving space 52 of the upper adjusting cover 5 and has a size smaller than that of the receiving space 52 of the upper adjusting cover 5. The stop flange 51 of the upper adjusting cover 5 has an annular shape and extends radially and outwardly from the upper adjusting cover 5. The stop flange 51 of the upper adjusting cover 5 is movable in and guided by the guide grooves 22 of the lower adjusting cover 2.

The elastic member 4 is mounted on the threaded portion 32 of the threaded rod 3 and received between the receiving space 52 of the upper adjusting cover 5 and the receiving chamber 21 of the lower adjusting cover 2. The elastic member 4 is biased between the driven portion 33 of the threaded rod 3 and the limit shoulder 54 of the upper adjusting cover 5 to push the upper adjusting cover 5 outwardly relative to the lower adjusting cover 2 until the stop flange 51 of the upper adjusting cover 5 is stopped by the stop portions 23 of the lower adjusting cover 2.

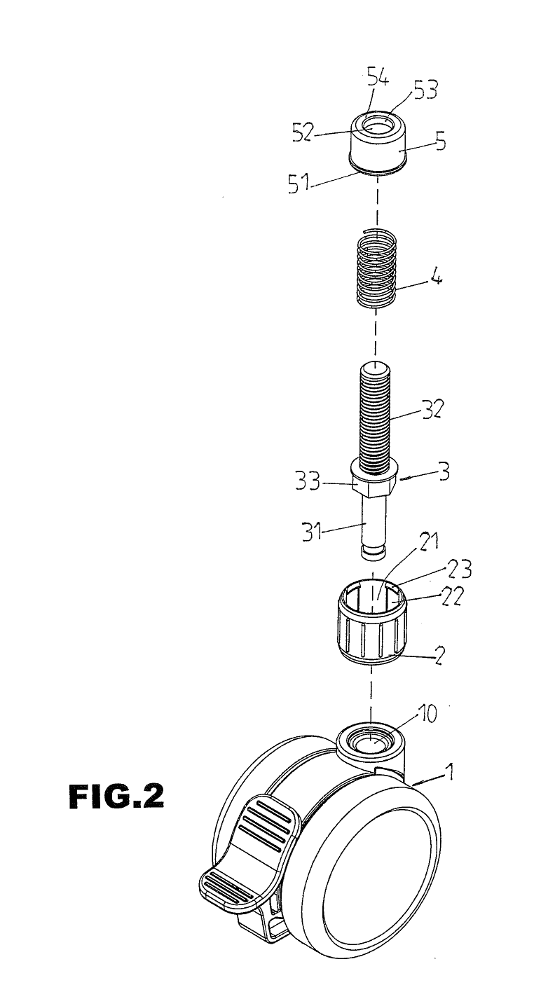

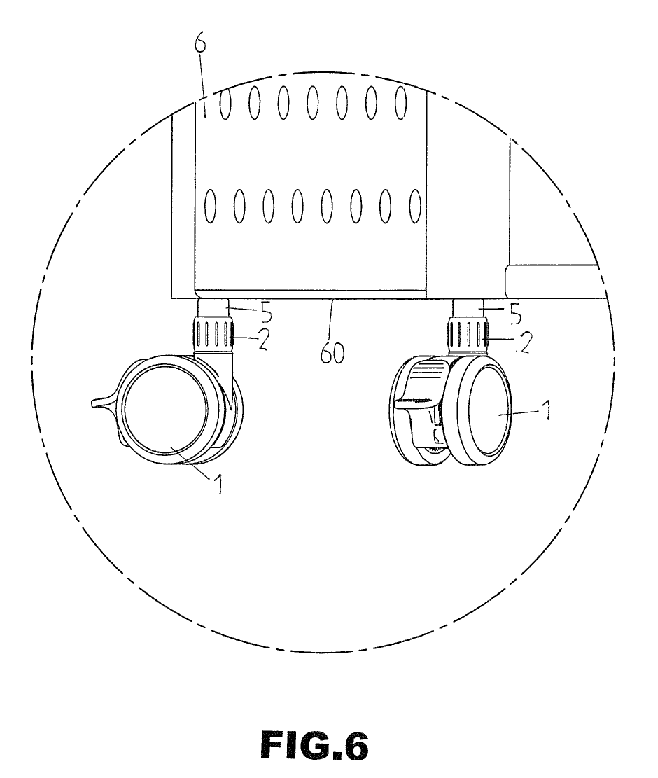

In operation, referring to FIGS. 3-7 with reference to FIGS. 1 and 2, the drive hole 24 of the lower adjusting cover 2 is secured on the driven portion 33 of the threaded rod 3 so that when the lower adjusting cover 2 is rotated, the threaded rod 3 is also rotated by the lower adjusting cover 2. In such a manner, when the castor assembly is mounted on an object 6, such as a chair, a case or the like, the threaded rod 3 is rotated by the lower adjusting cover 2 and is screwed into the bottom 60 of the object 6 until the upper adjusting cover 5 abuts the bottom 60 of the object 6 as shown in FIG. 6. At this time, the threaded rod 3 is disposed between the bottom 60 of the object 6 and the castor body 1 and is fully covered by the lower adjusting cover 2 and the upper adjusting cover 5 to enhance the aesthetic quality of the castor assembly.

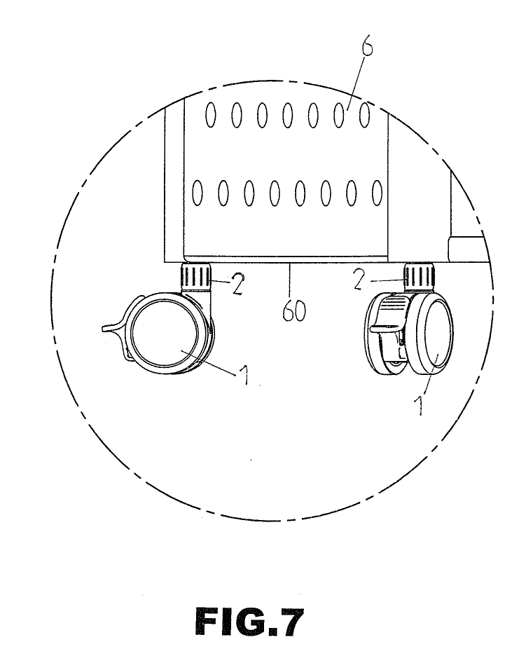

In adjustment, when a user wishes to adjust the distance between the castor assembly and the object 6, the threaded rod 3 is again rotated by the lower adjusting cover 2 and is further screwed into the bottom 60 of the object 6 so as to adjust the height of the castor body 1. At this time, the upper adjusting cover 5 is compressed by the bottom 60 of the object 6 during movement of the threaded rod 3 and is retracted into the receiving chamber 21 of the lower adjusting cover 2 as shown in FIGS. 5 and 7.

Accordingly, the drive hole 24 of the lower adjusting cover 2 is secured on the driven portion 33 of the threaded rod 3 so that the threaded rod 3 is rotated by the lower adjusting cover 2 and is screwed into and moved in the bottom 60 of the object 6 so as to adjust the height of the castor body 1. In addition, the threaded rod 3 is disposed between the bottom 60 of the object 6 and the castor body 1 and is fully covered by the lower adjusting cover 2 and the upper adjusting cover 5 to enhance the aesthetic quality of the castor assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A castor assembly, comprising:
a castor body;
a threaded rod rotatably mounted on the castor body;
a lower adjusting cover surrounding the threaded rod to cover the threaded rod and secured on the threaded rod to rotate the threaded rod relative to the castor body;
an upper adjusting cover surrounding the threaded rod to cover the threaded rod and retractably mounted on the lower adjusting cover; and
an elastic member mounted on the threaded rod and biased between the threaded rod and the upper adjusting cover to push the upper adjusting cover outwardly relative to the lower adjusting cover.

2. The castor assembly of claim 1, wherein
the threaded rod has an upper end provided with a threaded portion, a lower end provided with a plug, and a mediate portion provided with a driven portion located between the plug and the threaded portion;
the lower adjusting cover has an inner portion provided with a receiving chamber to receive the threaded rod and the elastic member;
the inner portion of the lower adjusting cover has a lower end provided with a drive hole secured on the driven portion of the threaded rod to drive and rotate the driven portion of the threaded rod relative to the castor body.

3. The castor assembly of claim 2, wherein
the driven portion of the threaded rod has a substantially hexagonal profile;
the drive hole of the lower adjusting cover has a substantially hexagonal profile.

4. The castor assembly of claim 2, wherein
the inner portion of the lower adjusting cover has an upper end provided with a plurality of stop portions;
the upper adjusting cover has a lower end provided with a stop flange movably mounted in the receiving chamber of the lower adjusting cover and movable to abut the stop portions of the lower adjusting cover.

5. The castor assembly of claim 4, wherein
the inner portion of the lower adjusting cover has a periphery provided with a plurality of elongate and arcuate guide grooves connected to the receiving chamber and aligning with the stop portions respectively;
the stop flange of the upper adjusting cover is movable in and guided by the guide grooves of the lower adjusting cover.

6. The castor assembly of claim 2, wherein the castor body is provided with a mounting recess rotatably mounted on the plug of the threaded rod.

7. The castor assembly of claim 6, wherein the drive hole of the lower adjusting cover is connected between the mounting recess of the castor body and the receiving chamber of the lower adjusting cover.

8. The castor assembly of claim 7, wherein the plug of the threaded rod is inserted through the receiving chamber and the drive hole of the lower adjusting cover into the mounting recess of the castor body.

9. The castor assembly of claim 2, wherein the upper adjusting cover has an inner portion provided with a receiving space connected to the receiving chamber of the lower adjusting cover to receive the threaded rod and the elastic member.

10. The castor assembly of claim 9, wherein
the upper adjusting cover has an upper end provided with a limit shoulder to limit the elastic member;
the limit shoulder of the upper adjusting cover extends radially and inwardly from the upper adjusting cover and has an inner portion provided with a through hole to allow passage of the threaded rod;
the through hole of the upper adjusting cover is connected to the receiving space of the upper adjusting cover;
the elastic member is biased between the driven portion of the threaded rod and the limit shoulder of the upper adjusting cover to push the upper adjusting cover outwardly relative to the lower adjusting cover until the stop flange of the upper adjusting cover is stopped by the stop portions of the lower adjusting cover.

11. The castor assembly of claim 10, wherein the elastic member is mounted on the threaded portion of the threaded rod and received between the receiving space of the upper adjusting cover and the receiving chamber of the lower adjusting cover.

12. The castor assembly of claim 1, wherein
the threaded rod is rotatable relative to the upper adjusting cover and is movable axially relative to the upper adjusting cover;
the lower adjusting cover is rotatable relative to the upper adjusting cover and is movable axially relative to the upper adjusting cover.

13. The castor assembly of claim 1, wherein the threaded rod is fully covered by the lower adjusting cover and the upper adjusting cover.

14. The castor assembly of claim 1, wherein the lower adjusting cover is disposed between the castor body and the upper adjusting cover.

15. The castor assembly of claim 10, wherein the through hole of the upper adjusting cover has a size smaller than that of the receiving space of the upper adjusting cover.

16. The castor assembly of claim 4, wherein the stop flange of the upper adjusting cover has an annular shape and extends radially and outwardly from the upper adjusting cover.

17. The castor assembly of claim 2, wherein the driven portion of the threaded rod has a size greater than that of the plug and greater than that of the threaded portion.

18. The castor assembly of claim 6, wherein the mounting recess of the castor body has a size smaller than that of the driven portion of the threaded rod.

19. The castor assembly of claim 2, wherein the drive hole of the lower adjusting cover extends radially and inwardly from the lower adjusting cover and has a size smaller than that of the receiving chamber of the lower adjusting cover.

20. The castor assembly of claim 1, wherein the upper adjusting cover protrudes outwardly from the lower adjusting cover at a normal state and is retractable into the receiving chamber of the lower adjusting cover.
